(19) United States
(12) Patent Application Publication
(10) Pub. No.: US 2016/0176533 A1
(43) Pub. Date: Jun. 23, 2016

(54) REMOVABLE AUXILIARY POWER DEVICE FOR AIRCRAFT AND AIRCRAFT ADAPTED TO USE AT LEAST ONE SUCH DEVICE

(71) Applicant: Airbus Operations SAS, Toulouse (FR)

(72) Inventors: Olivier Cazals, Blagnac (FR); Thierry Druot, Saint-Jean (FR); Julien Guillemaut, Toulouse (FR)

(73) Assignee: Airbus Operations SAS, Toulouse (FR)

(21) Appl. No.: 14/974,660

(22) Filed: Dec. 18, 2015

(30) Foreign Application Priority Data
Dec. 19, 2014 (FR) FR 1462893

(51) Int. Cl. B64D 27/24; B64D 41/00; B64D 29/02; B64C 3/32; B64C 11/00

(52) U.S. Cl. CPC B64D 27/24; B64C 3/32; B64C 11/00; B64D 29/02; B64D 41/00; B64D 2041/002

(57) ABSTRACT

An auxiliary power device may be exteriorly removably connected to an aircraft in order to allow the increase of the performance data of the aircraft, namely at take-off and landing. The auxiliary power device includes a propeller (or fan) connected to an electric engine fed by an electric power supply.

### FIELD OF THE INVENTION

The present invention concerns a removable auxiliary power device for aircraft and an aircraft adapted to use or including at least one such auxiliary power device.

### BACKGROUND OF THE INVENTION

It is known that the users of aircraft look for maximum flexibility for the aircraft that they operate, in order to obtain the most appropriate services. However, for reasons of construction cost and operating cost, the basic performance of these aircraft is generally optimized for the basic missions that these aircraft must carry out and could not be enhanced if these aircraft had to carry out missions requiring higher performance.

### BRIEF SUMMARY OF THE INVENTION

Aspects of the present invention may remedy these drawbacks by making it possible, when required, to enhance the basic performance of an aircraft without in so doing increasing the operating costs when said aircraft carries out a basic mission not necessitating enhanced performance An aspect of the present invention notably enables an aircraft to access airports with runways that would be too short to land and take off without difficulty with its basic performance

To this end, in accordance with the invention, the auxiliary power device for aircraft is noteworthy:

in that it includes at least one electric motor, a power supply for said electric motor and a propeller (or fan) connected to said electric motor and able to generate at least one of the following forces: a propulsion force, a reverse force in the opposite direction to the direction of the speed of the aircraft; and

in that it is externally connectable in a removable fashion to said aircraft and is configured so that it can be mounted and demounted on the ground.

Accordingly, thanks to the present invention, if the mission that the aircraft has to carry out necessitates performance better than its basic performance, there is connected to said aircraft, on the ground before this mission, at least one auxiliary power device that can confer on the latter the additional performance delivered by said propeller. The auxiliary power device, mounted (or installed) in this way, remains in place on the aircraft throughout the flight and throughout the mission. On the other hand, as soon as this mission necessitating higher performance is completed, the auxiliary power device can be demounted, on the ground, so that the aircraft resumes its basic performance and configuration for a new mission.

Since a propeller (or fan) can function in propulsion mode or in reverse mode, it is clear that, in the event of taking off from a runway that is too short for the basic performance of the aircraft, the latter can receive from the auxiliary power device operating in propulsion mode additional power enabling it to take off without impediment and that, conversely, in the event of landing on such a runway, said auxiliary power device, then operating in the reverse mode, generates a force opposite the speed contributing to the braking of said aircraft.

In a simplified embodiment, the propeller is configured to generate only a propulsion force. Moreover, in another embodiment, the propeller is configured to be able to generate one or the other of said forces (propulsion force, reverse force) as required.

Such an ability of the auxiliary power device to operate in propulsion mode or in reverse mode may result from the fact that the propeller (or fan) can turn in both rotation directions or is equipped with a pitch variation device.

The electrical power supply of the auxiliary power device in accordance with the present invention may be formed by at least one battery or by at least one super capacitor.

In the particular case where the auxiliary power device is intended for a civil transport aircraft, the mass of the electrical power supply may notably be of the order of 100 kg to more than 1000 kg and the power supplied by the propeller (or fan) may be of the order of 50 kVA to more than 1000 kVA.

The auxiliary power device preferably includes a nacelle enclosing at least said electric motor and said electrical power supply, and a pylon adapted to connect said nacelle to said aircraft. To this end, this auxiliary power device may include a removable connection device disposed at the opposite end of said pylon to said nacelle.

In the auxiliary power device, said propeller (or fan) may be disposed on the upstream side or on the downstream side of said nacelle relative to the aerodynamic flow around the aircraft.

The present invention further concerns an aircraft able to use at least one auxiliary power device as specified above, that aircraft being noteworthy in that it includes at least one removable connection device, accessible from the outside, able to receive said auxiliary power device, notably by cooperating with a removable connection device rigidly fastened to said auxiliary power device.

When said aircraft includes two wings symmetrical with respect to its longitudinal axis, it may include at least two removable connection devices carried by said wings and, for balancing purposes, dispose symmetrically with respect to each other relative to said longitudinal axis.

The removable connection device(s) of said aircraft is (are) advantageously disposed in the lower part thereof, so that said auxiliary power devices are suspended from said aircraft. They are then particularly accessible for maintenance purposes.

Alternatively, the connection of the auxiliary power device(s) may be situated at the level of the fuselage, for example laterally at the level of the aft portion of the fuselage.

The present invention further concerns an aircraft equipped with at least one auxiliary power device as specified above, said auxiliary power device being removably connected to said aircraft.

### BRIEF DESCRIPTION OF THE DRAWINGS

The appended figures show clearly how the invention can be implemented. In these figures, identical references designate similar elements.

FIG. 1 shows, in diagrammatic perspective, an auxiliary power device in accordance with one embodiment of the present invention, mounted externally on an aircraft portion.

FIG. 2 is a diagrammatic and partially cutaway lateral view of the auxiliary power device from FIG. 1.

FIG. 3 shows, in diagrammatic lateral view similar to FIG. 2, the auxiliary power device separated from the aircraft portion.

FIG. 4 shows, in a perspective view from the front and from above, an aircraft equipped with two auxiliary power devices in accordance with the present invention.

FIG. 5 is a front view of the aircraft from FIG. 4.

FIG. 6 shows, in a perspective view from the rear and from above, a variant of the aircraft from FIGS. 4 and 5.

### DETAILED DESCRIPTION

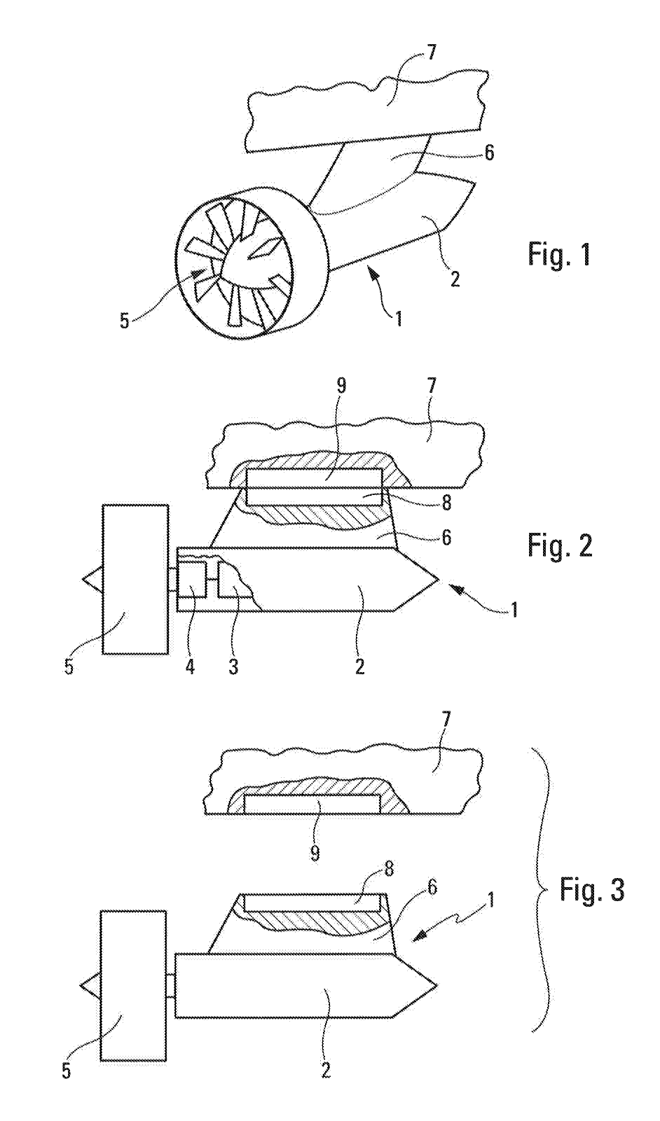

The auxiliary power device 1, enabling the present invention to be illustrated and represented in FIGS. 1, 2 and 3, includes a nacelle 2 containing at least one electrical power supply 3, such as at least one battery or at least one supercapacitor, an electric motor 4 and associated control electronics. The power supply 3 and the electric motor 4 are adapted to drive rotation of a propeller 5, possibly faired, external to the nacelle 2 and able to turn in both directions or provided, in a manner that is known and not shown, with a pitch variation device.

The nacelle 2 is rigidly fastened to a pylon 6 that is adapted to connect it removably to an exterior portion 7 of an aircraft. To this end, at its end opposite the nacelle 2, the pylon 6 includes a connection device 8 able to cooperate in removable fashion with a connection device 9 provided on said exterior aircraft portion 7.

In FIGS. 2 and 3, the cooperating connection devices 8 and 9 are not represented in detail as they may be of any known type, such as for example those used on combat aircraft to carry weapon systems.

As FIGS. 2 and 3 show, the cooperating connection devices 8 and 9 make possible removable fixing of the power device 1 to the exterior aircraft portion 7 (FIG. 2), and separation of the power device from said exterior aircraft portion 7 (FIG. 3).

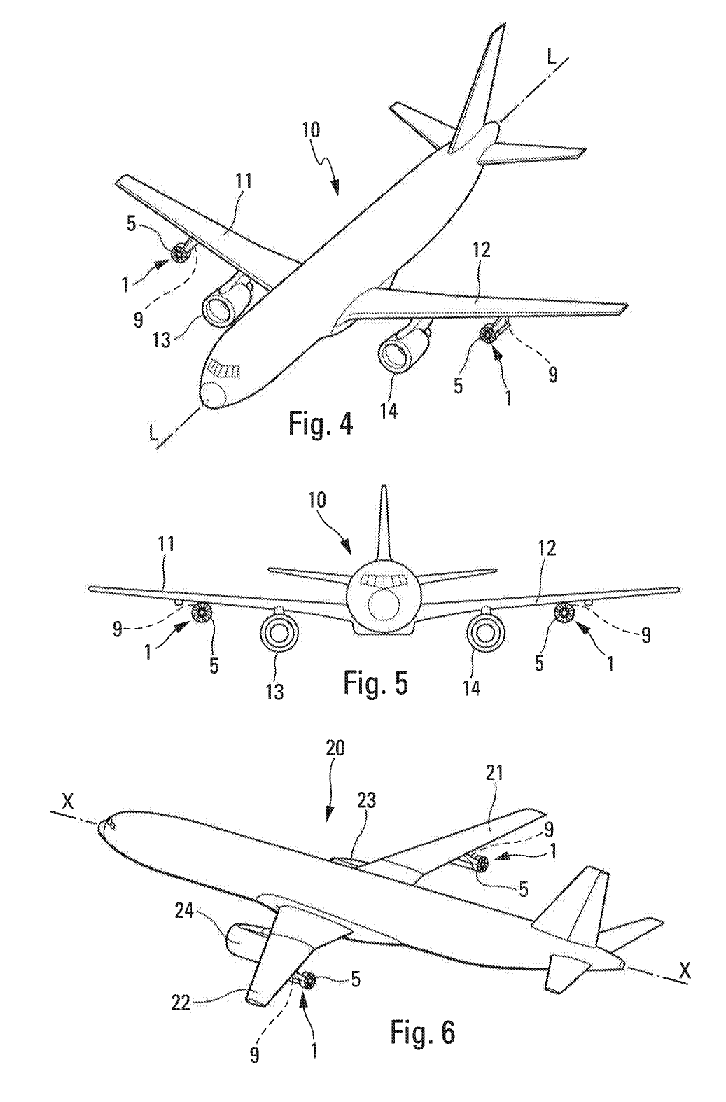

In FIGS. 4 and 5 there is represented a civil aircraft 10 the wings 11 and 12 of which each support a respective turbine engine 13 and 14. Moreover, each of said wing supports, in the manner described with reference to FIGS. 1 to 3 for the exterior aircraft portion 7, an auxiliary power device 1, the two auxiliary power devices 1 being symmetrical to each other with respect to the longitudinal axis L-L of the civil aircraft 10.

As FIGS. 4 and 5 show, it is assumed that in this civil aircraft 10 the propellers 5 of the auxiliary power devices 1 are disposed on the upstream side of said nacelle 2 relative to the aerodynamic flow around said aircraft 10.

On the other hand, in the civil aircraft 20 with two wing mounted engines 23 and 24 represented in FIG. 6, the wings 21 and 22 also carry two auxiliary power devices 1, symmetrical to each other with respect to the longitudinal axis X X of said aircraft 20, but the propellers 5 of the auxiliary power devices 1 are disposed on the downstream side of said nacelle 2 relative to the aerodynamic flow around said aircraft 20.

The power delivered by the propeller 5 of each device 1 of the aircraft 10 and 20 may be of the order of 50 kVA to 1000 kVA or more, while the mass of the electric supply 3 may be of the order of 100 kg to 1000 kg or more.

In a manner that is not represented in FIGS. 1 and 3, the nacelle 2 includes opening covers providing access to its interior, notably for maintenance of the power supply 3, the electric motor 4 and the associated electronics.

The maintenance operations are greatly facilitated if, as shown in FIGS. 1 to 3, the auxiliary power device 1 is suspended under the exterior aircraft portion 7 by its pylon 6. However, this auxiliary power device may be disposed laterally relative to the fuselage of the aircraft 10 and 20, for example in the aft portion of that fuselage.

From the foregoing description, it is easily understood that the auxiliary power devices 1 can be used not only to enable the aircraft 10 and 20 to take off from and land on short runways, as indicated above, but also to move these aircraft on the ground, notably when the turbine engines 13, 14 and 23, 24 are not running

When the auxiliary power devices 1 are installed on an aircraft and the latter is moving because of the action of its turbine engines, the propellers of these auxiliary power devices 1 are driven in rotation, by virtue of the electrical energy coming from the generators associated with the turbine engines, which makes it possible to improve the dilution level of the overall propulsion system of said aircraft.

Moreover, as is generally the case for civil transport aircraft, when the aircraft 10, 20 includes an auxiliary power unit APU intended to enable ancillary services to be provided on the ground when the turbine engines are not running, it is possible to power the auxiliary power devices 1 at least in part from this APU. Accordingly, thanks to the present invention, the power produced by the latter can then serve to propel the aircraft.

Moreover, it will be noted that:

the electric power supply 3 of an auxiliary power device 1 can be charged not only on the ground during maintenance operations but also in flight thanks to the device 1 operating in windmill mode;

the positioning of the auxiliary power devices 1 externally of the aircraft 10, 20 enables not only easy access to the components 3, 4 that they contain but also effective cooling thereof, notably by convection, which enhances safety; and

the connection device or devices 9 provided on the aircraft 7, 10, 20 can receive different removable auxiliary power devices, adapted to different requirements, so as to be able to change the auxiliary power device (1) as required.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An auxiliary power device for aircraft, said auxiliary power device comprising:
at least one electric motor;
an electrical power supply for said electric motor; and
a propeller connected to said electric motor and able to generate at least one of the following forces: a propulsion force, a reverse force in the opposite direction to the direction of the speed of the aircraft, said auxiliary power device being externally connectable in removable fashion to said aircraft and being configured so that the auxiliary power device can be mounted and demounted on the ground.

2. The auxiliary power device as claimed in claim 1, wherein said propeller can turn in both directions.

3. The auxiliary power device as claimed in claim 1, wherein said propeller is equipped with a pitch variation device.

4. The auxiliary power device as claimed in claim 1, wherein the power delivered by said propeller is of the order of 50 to more than 1000 kVA.

5. The auxiliary power device as claimed in claim 1, wherein said electrical power supply is at least one battery or at least one supercapacitor and in that the mass of said electrical power supply is of the order of 100 to more than 1000 kg.

6. The auxiliary power device as claimed in claim 1, further comprising:
a nacelle enclosing at least said electric motor and said electrical power supply; and
a pylon adapted to connect said nacelle to said aircraft.

7. The auxiliary power device as claimed in claim 6, wherein said propeller is disposed on the upstream side of said nacelle relative to the aerodynamic flow.

8. The auxiliary device as claimed in claim 6, wherein said propeller is disposed on the downstream side of said nacelle relative to the aerodynamic flow.

9. An aircraft adapted to use at least one auxiliary power device comprising:
at least one electric motor;
an electrical power supply for said electric motor; and
a propeller connected to said electric motor and able to generate at least one of the following forces: a propulsion force, a reverse force in the opposite direction to the direction of the speed of the aircraft, said auxiliary power device being externally connectable in removable fashion to said aircraft and being configured so that the auxiliary power device can be mounted and demounted on the ground,
wherein the aircraft comprises at least one removable connection device accessible from the outside adapted to receive said auxiliary power device.

10. The aircraft as claimed in claim 9, having two wings symmetrical with respect to the longitudinal axis of said aircraft, wherein the aircraft comprises at least two removable connection devices carried by said wings and disposed symmetrically to each other with respect to said longitudinal axis.

11. The aircraft as claimed in claim 9, wherein the removable connection device of said aircraft is disposed in the lower part thereof so that said auxiliary power device(s) are suspended from said aircraft.

12. An aircraft comprising:
at least one auxiliary power device comprising:
at least one electric motor;
an electrical power supply for said electric motor; and
a propeller connected to said electric motor and able to generate at least one of the following forces: a propulsion force, a reverse force in the opposite direction to the direction of the speed of the aircraft, said auxiliary power device being externally connectable in removable fashion to said aircraft and being configured so that the auxiliary power device can be mounted and demounted on the ground, said auxiliary power device being removably connected to said aircraft.
